(19) United States
(12) Patent Application Publication
(10) Pub. No.: US 2005/0204886 A1
(43) Pub. Date: Sep. 22, 2005

(54) Hole punch device having punch elements with non-circular cutting surfaces

(76) Inventor: Pamela K. Lowenthal, Chicago, IL (US)

Correspondence Address: Cynthia L. Smith;Barnes & Thornburg, P.O. Box 2786, Chicago, IL, 60690-2786, US

(21) Appl. No.: 10/803,275

(22) Filed: Mar. 18, 2004

(51) Int. Cl. B26F 1/14

(52) U.S. Cl. 83/588; 83/618

(57) ABSTRACT

The disclosed invention provides a dual hole punch for perforating at least one sheet of paper with dual non-circular holes. The dual hole punch may be configured to deliver dual non-circular perforations to paper positioned in either a substantially horizontal or substantially vertical direction. For receipt of paper positioned in a substantially horizontal direction, the dual hole punch includes a base plate upon which is mounted a guide bracket. The guide bracket is mounted to the base plate and is configured with two bores. Each of the bores include a reciprocally moveable, spring biased punch having bottom end non-circular cutting surfaces. When a lever, pivotally mounted to the guide bracket and coupled to top surfaces of the punches, is actuated towards the base plate, the non-circular cutting surfaces of the dual punches perforate the sheet(s) of paper with non-circular holes. An optional adjustable paper guide assembly may also be included.

### FIELD OF THE DISCLOSURE

This invention is directed to hole punch devices, and more particularly, to a hole punch device having punch elements with non-circular cutting surfaces.

### BACKGROUND

Hole punch devices having dual punch elements with circular cutting surfaces are used to create dual circular perforations, typically having centers 2.75 inches apart, in a top portion of one or more sheets of paper. Once perforated, the sheets of paper are then slideably mounted, via the dual circular perforations, onto a standard two-prong fastener mounted to a file folder. Such two-prong fasteners generally include two flexible prongs (e.g., aluminum, plastic) that are extendable upward from a surface (e.g., a file folder) to receive the perforated sheets of paper, and are foldable against the surface to secure the paper in place.

The two prongs of the two-prong fasteners are typically designed as elongated flat prongs having a thin rectangular cross-section. By definition however, a standard circular perforation has a constant radius extending from its midpoint to any location on its circumference. As a result of their disparate shapes, use of the elongated flat prongs in conjunction with standard circular perforations often results in tearing of the sheets of paper in the area of the perforations.

### SUMMARY OF THE INVENTION

The present invention provides a dual hole punch with a substantially horizontal engaging surface for perforating at least one sheet of paper with dual non-circular holes. The dual hole punch includes a base plate having an engaging surface for substantially horizontal paper engagement, a guide bracket having a first portion fixedly mounted to a first portion of the engaging surface and having the second portion extending adjacent to and spaced apart from a second portion of the engaging surface to define a substantially horizontal slot having a wall surface therebetween, where the second portion of the guide bracket includes a first and second bore extending therethrough and perpendicular to the engaging surface. The dual hole punch also includes a lever arm pivotally mounted to the guide bracket and having a first and second bearing surface, a first punch disposed in the first bore and a second punch disposed in the second bore. Each of the first and second punches include a top end surface engagedly coupled to their respective bearing surfaces of the lever arm, and an opposing bottom end non-circular cutting surface. When the lever is actuated towards the base plate, the bottom end non-circular cutting surfaces of the first and second punch perforate the sheet(s) of paper with non-circular holes.

The present invention also provides a vertical hole punch with a substantially vertical engaging surface for perforating paper with at least one non-circular hole. The hole punch includes a base plate and a guide bracket attached to a top surface of the base plate. The guide bracket has a first lower portion and at least one second upper portion where the second upper portion extends upward from the first lower portion in a substantially vertical direction, and a wall surface extending outward from an outer surface of the second upper portion of the guide bracket. The hole punch also includes a side plate having an engagement surface extending in the substantially vertical direction. The side plate has a lower portion disposed adjacent to and spaced apart from the second upper portion of the guide bracket. The wall surface of the guide bracket, the second upper portion of the guide bracket and the lower portion of the side plate form a slot adapted to support the paper in a substantially vertical direction. The hole punch further includes a punch assembly mounted in the guide bracket where the punch assembly includes at least one reciprocally and selectively driven punch that has a top end surface and an opposing bottom end non-circular cutting surface. In addition, the side plate includes at least one die adapted to receive the bottom end non-circular cutting surface of the at least one punch when the at least one punch is driven towards the side plate by the punch assembly.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 a perspective view of an exemplary dual hole punch having dual punch elements with non-circular cutting surfaces in accordance with the invention;

FIG. 2 is top view of the exemplary dual hole punch of FIG. 1;

FIG. 3 is a cut-away side view of the exemplary dual hole punch of FIG. 1 in a non-engaged position;

FIG. 4 is a cut-away side view of the exemplary dual hole punch of FIG. 1 in an engaged position;

FIG. 5 is a top view of a rectangular perforation pattern created in a sheet of paper by the exemplary dual hole punch of FIG. 1;

FIG. 6 is a top view of an oval perforation pattern created in a sheet of paper by the exemplary dual hole punch of FIG. 1;

FIG. 7 is a top view of a D-shaped perforation pattern created in a sheet of paper by the exemplary dual hole punch of FIG. 1;

FIG. 8 is a top view of a modified D-shaped perforation pattern created in a sheet of paper by the exemplary dual hole punch of FIG. 1;

FIG. 9 is a cut-away side view another exemplary dual hole punch in accordance with the invention.

### DESCRIPTION OF THE PREFERRED EXAMPLES

The description of the preferred examples is to be construed as exemplary only and does not describe every possible embodiment of the invention. Numerous alternative embodiments could be implemented, using either current technology or technology developed after the filing date of this patent, which would still fall within the scope of the claims defining the invention.

In general, the present invention provides a dual hole punch that may be configured to deliver dual non-circular perforations to paper positioned in either a substantially horizontal or substantially vertical direction. For receipt of paper positioned in a substantially horizontal direction, the dual hole punch includes a base plate upon which is mounted a guide bracket. The guide bracket is mounted to the base plate and is configured with two bores. Each of the bores include a reciprocally moveable, spring biased punch having bottom end non-circular cutting surfaces. When a lever, pivotally mounted to the guide bracket and coupled to top surfaces of the punches, is actuated towards the base plate, the non-circular cutting surfaces of the dual punches perforate the sheet(s) of paper with non-circular holes. For receipt of paper positioned in a substantially vertical direction, the dual hole punch additionally includes a vertically positioned side plate mounted to the base plate. An optional adjustable paper guide assembly may also be included.

Substantially Horizontal Engagement of the Paper

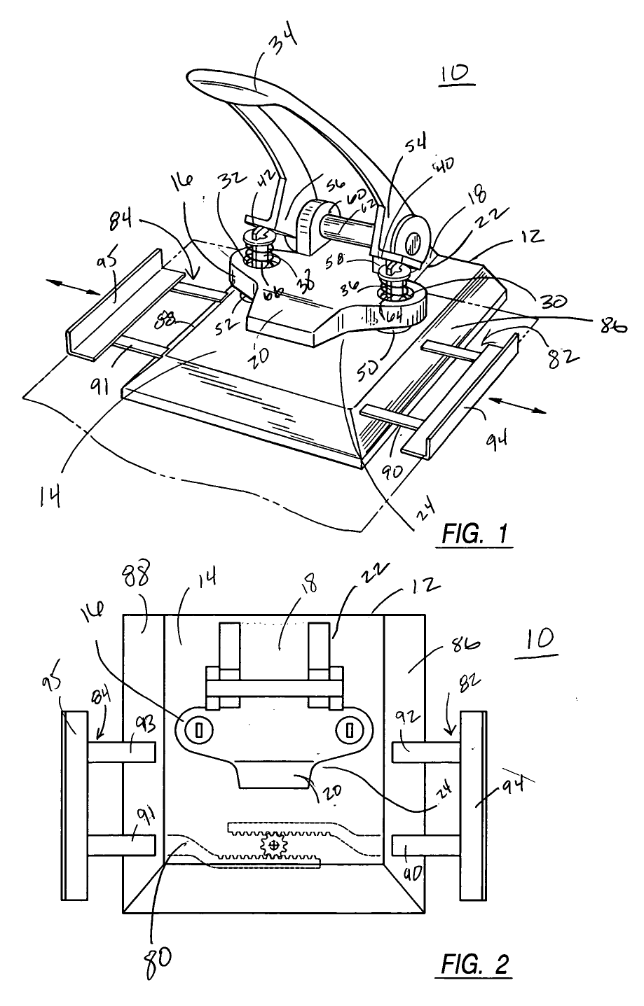

FIG. 1 a perspective view of an exemplary dual hole punch 10 having dual punch elements with non-circular cutting surfaces in accordance with the invention. The dual hole punch 10 includes a base plate 12 having an engaging surface 14 for substantially horizontal engagement of one or more sheets of paper. As used herein, the term “substantially horizontal” may be defined to include a range of degrees. For example, the engaging surface may be exactly horizontal (i.e., 0 degrees from the horizontal) or it may slope downward near the punching apparatus to optimize paper positioning utilizing the force of gravity (i.e., −5 degrees from the horizontal).

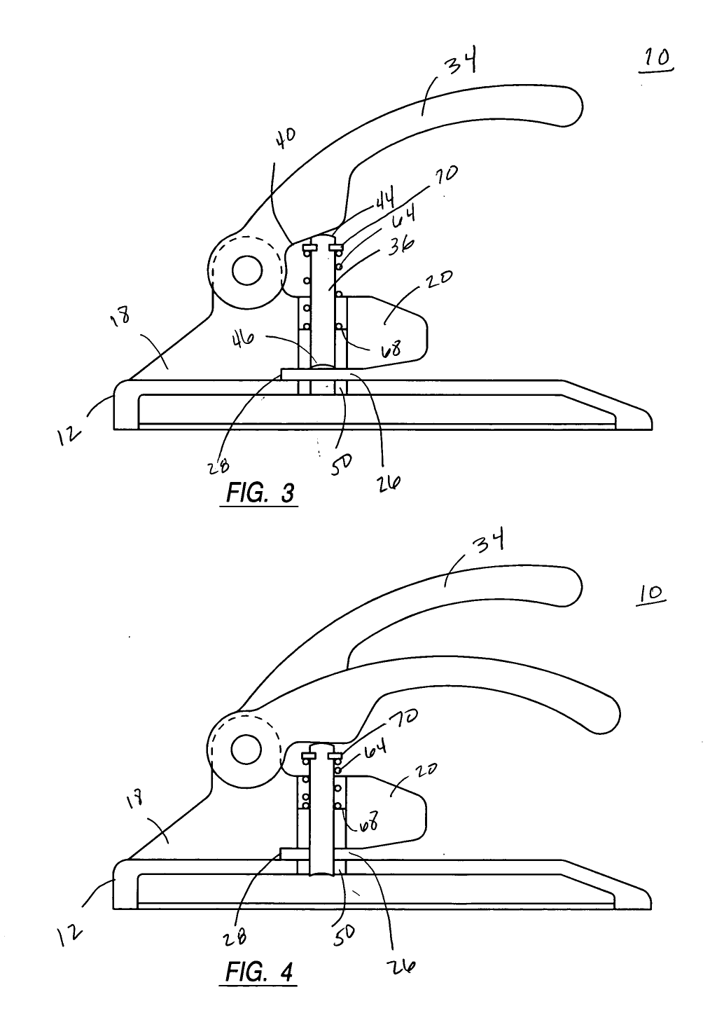

The dual hole punch 10 also includes a guide bracket 16 having a first portion 18 and a second portion 20 extending from the first portion 18. The first portion 18 of the guide bracket is mounted to a first portion 22 of the engaging surface 14. The second portion 20 of the guide bracket 16 extends adjacent to, and spaced apart from, a second portion 24 of the engaging surface 14 to define a substantially horizontal slot 26 having a wall surface 28 (see, FIG. 3) extending between the engaging surface 14 and the second portion 20 of the guide bracket 16. The second portion 20 of the guide bracket 16 includes a first bore 30 and a second bore 32. Both the first bore 30 and the second bore 32, spaced apart from the first bore 30, extend through the second portion 20 of the guide bracket 16 and are perpendicular to the engaging surface 14.

The dual hole punch 10 also includes a lever arm 34, and dual punches 36 and 38 disposed in the first and second bores 30, 32, repectively. The first punch 36 has a top end surface 44 and an opposing bottom end non-circular cutting surface 46 (see, FIG. 3). Similarly, the second punch 38 has a top end surface 48 and an opposing bottom end non-circular cutting surface 50.

The lever arm 34 is pivotally mounted to the guide bracket 16 and includes a first bearing surface 40 to engage the first punch 36 and a second bearing surface 42 to engage the second punch 38. The first bearing surface 40 extends outwardly from a first planar side wall 52 of the lever arm 34 to engage the top end surface 44 of the first punch 36. The second bearing surface 42 extends outwardly from a second planar side wall 54 of the lever arm 34 to engage the top end surface 48 of the second punch 38.

To enable rotative movement of the lever arm 34, the guide bracket 16 further includes a first upstanding flange 58 and a second upstanding flange 60. The first upstanding flange 58 is mounted to the top of the first portion 18 of the guide bracket 16 proximate to the first planar side wall 54 of the lever arm 34. The first upstanding flange 58 includes an aperture sized to receive a pivot pin 62. Likewise, the second upstanding flange 60 is mounted to the top of the first portion 18 of the guide bracket 16 proximate to the second planar side wall 56 of the lever arm 34, and includes an aperture sized to receive the pivot pin 62.

The pivot pin 62 is fixedly mounted between the first and second planar side wall 54, 56 of the lever arm 34, and extends through the apertures of the first and second upstanding flanges 58, 60 for rotative movement of the lever arm 34 about the pivot pin 62 during operation of the dual hole punch 10.

Two springs 64, 66 are disposed around the first and second punches 36, 38, respectively, and are adapted to enable reciprocal linear movement of the first and second punches 36, 38, and reciprocal rotational movement the lever arm 34. A first end of the first spring 64 is coupled to a first lip 68, radially disposed in the first bore 30, and a second end of the first spring 64 is coupled to a radially extending flange 70 disposed proximate to the top end surface 44 of the first punch 36 (see, FIG. 3). Similarly, a first end of the second spring 66 is coupled to a second lip 72, radially disposed in the second bore 32, and a second end of the second spring 66 is coupled to a radially extending flange 74 disposed proximate to the top end surface 46 of the second punch 38.

The engaging surface 14 of the base plate 12 includes a first and second die 50, 52 disposed therein and aligned with the punches 36, 38. The first die 50 defines an aperture configured to receive the bottom end non-circular cutting surface 46 of the first punch 36. Similarly, the second die 52 defines an aperture configured to receive the bottom end non-circular cutting surface 50 of the second punch 38.

During operation, when in the dual hole punch 10 is not engaged, the bottom end non-circular cutting surfaces 46, 50 of the first and second punches 36, 38 are retracted into their respective bores (positioned above the slot 26), thereby allowing the paper to be aligned under the first and second punches 36, 38. When in the dual hole punch 10 is engaged via downward actuation of the lever 34, the bottom end non-circular cutting surfaces 46, 50 travel through the horizontally positioned sheet of paper to the first and second dies 50, 52, below. When the lever 34 is released, the biasing forces of the first and second springs return the lever arm 34 to the non-engaged position. Accordingly, the paper is perforated with non-circular perforation patterns determined by the non-circular shape of the cutting surfaces 46, 50. FIG. 3 is a cut-away side view of the exemplary dual hole punch 10 in a non-engaged position. FIG. 4 is a cut-away side view of the exemplary dual hole punch of FIG. 1 in an engaged position.

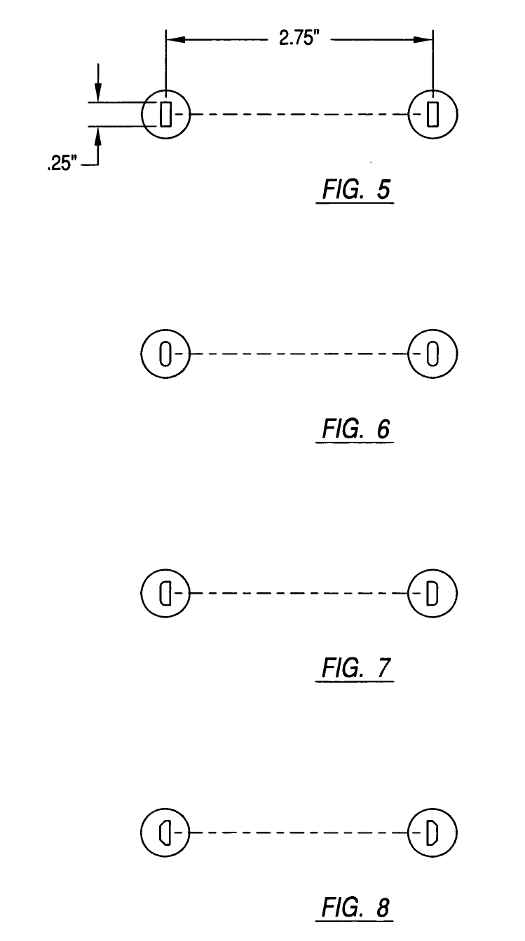

FIGS. 5-8 are top views of non-circular perforation patterns created in a sheet of paper by the bottom end non-circular cutting surfaces 46, 50 of the first and second punches 36, 38. FIG. 5 illustrates a rectangular pattern, FIG. 6 illustrates an elongated oval pattern, FIG. 7 illustrates a “D-shaped” pattern, and FIG. 8 illustrates a modified “modified D-shaped” pattern where the curved portions of the “D” are replaced with straight segments. It is contemplated that other suitable non-circular shapes may be utilized.

The centers of the bottom end non-circular cutting surfaces 46, 50 of the first and second punches 36, 38, respectively, are preferably spaced two and three-quarters inches apart to align with standard two-prong fastener devices, however, other distances are contemplated. Likewise, each of the non-circular perforations created by the bottom end non-circular cutting surfaces 46, 50 are preferably one-quarter of an inch in height to align with standard two-prong fastener devices, however, other heights are contemplated. In addition, although described as having a first and second punch 36, 38, it is contemplated that the dual hole punch may be expanded to a tri hole punch including three, a quad hole punch including four punches, etc., having bottom end non-circular cutting surfaces.

Referring again to FIGS. 1 and 2, the dual hole punch 10 may also include an exemplary adjustable paper guide assembly 80 to position the sheets of paper into a desired alignment (e.g., a centered alignment) with respect to the first and second punches 36, 38. In a preferred embodiment, the adjustable paper guide assembly 80 includes a first and second rod assembly 82, 84. The first rod assembly 82 is adapted to reciprocally move within aligned apertures formed in a first side 86 of the base plate 12. The first rod assembly 82 includes a first and second reciprocally moveable rod 90, 92, and an angle bracket 94 perpendicularly mounted to a first end of the first and second rods 90, 92. Likewise, the second rod assembly 84 is adapted to reciprocally move within aligned apertures formed in a second side 88 of the base plate 12. The second rod assembly 84 includes a first and second reciprocally moveable rod 91, 93, and an angle bracket 95 perpendicularly mounted to a first end of the first and second rods 91, 93. Although illustrated using dual rods, the first and second rod assembly 82, 84 may include more or less rods. Additionally, although illustrated using an angle bracket, it is contemplated that in another embodiment, the first and second rod assembly 82, 84 may be constructed without an angle bracket or may be constructed with cross member rods for added reinforcement.

In the illustrated example of FIG. 2, the first rod 90 of the first rod assembly 82 is interlinked to the first rod 91 of the second rod assembly 84 such that linear reciprocal movement of the first rod assembly 82 causes equal linear reciprocal movement of the second rod assembly 84, and vice versa. The equal linear reciprocal movement enables the sheet(s) of paper to be centered under the punches. Although interlinked via a dual rack and pinion assembly in the illustrated example, it is contemplated that the first and second rod assemblies 82, 84 may be interlinked for equal linear reciprocal movement using one of any number of suitable methods.

Substantially Vertical Engagement of the Paper

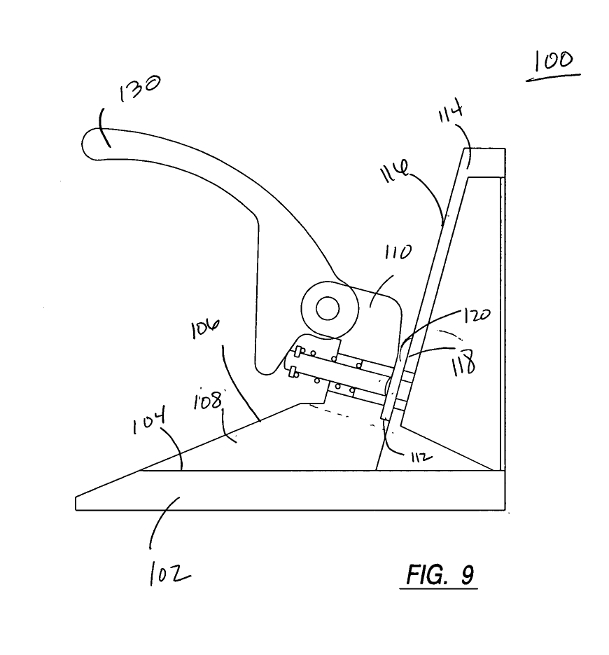

The dual hole punch may also be configured with a substantially vertical engaging surface. FIG. 9 is a side view of another exemplary dual hole punch 100 including punches having bottom end non-circular cutting surfaces in accordance with the invention. Although described below as having two punches, the dual hole punch 100 may include more or less punches, for example, one punch or three punches.

Referring to FIG. 9, the dual hole punch 100 includes a base plate 102 having a top surface 104 and a guide bracket 106 attached to the top surface 104 of the base plate 102. The guide bracket 106 includes a first lower portion 108 and a second upper portion 110. The second upper portion 110 extends upward from the first lower portion 108 in a substantially vertical direction. The guide bracket 106 also include a wall surface 112 extending outward from an outer surface of the second upper portion 110 of the guide bracket 108.

The dual hole punch 100 also includes a side plate 114 having an engagement surface 116 extending in a substantially vertical direction. A lower portion 118 of the side plate 114 is adjacent to and spaced apart from the second upper portion 110 of the guide bracket 106. Thus, the wall surface 112 of the guide bracket 106, the second upper portion 110 of the guide bracket 106 and the lower portion 118 of the side plate 114 form a slot 120 adapted to support sheet(s) of paper in the substantially vertical direction. Although configured with an angle approximately 20 degrees from the vertical, the engagement surface 116 may be configured in one of an infinite number of suitable angles from the vertical to enable gravity assisted placement of sheet(s) of paper in the dual hole punch 100.

As used herein, the term “substantially vertical” may be defined to include a range of degrees from the vertical. For example, the engaging surface may be exactly vertical (i.e., 90 degrees from the horizontal) or it may slope away from the vertical to optimize paper positioning utilizing the force of gravity (i.e., 60 degrees from the horizontal).

The dual hole punch 100 further includes a punch assembly, mounted in the guide bracket 116, that is operable as described in connection with the dual hole punch 10 having the substantially horizontal engagement surface. The punch assembly of the dual hole punch 100 includes a first and second punch where each punch includes a top end surface and an opposing bottom end non-circular cutting surface. Unlike, the dual hole punch 10, however, the first and second dies of the dual hole punch 100 are located in the side plate 114 rather than in the base plate 102. Thus, the first and second dies are adapted to receive the bottom end non-circular cutting surfaces of the first and second punches, respectively, as the first and second punches are driven towards the side plate by the punch assembly.

Similar to the dual hole punch 10, the second portion 110 of the guide bracket 106 of the dual hole punch 100 includes a first bore and a second bore spaced apart from the first bore. Both bores extend through the second portion 116 of the guide bracket 106 and are perpendicular to the substantially vertical engaging surface 116. A lever arm 130 for downward actuation is pivotally mounted to the second portion 110 of the guide bracket 106, and includes a first and second bearing surface for engagement with the top end surfaces of the respective punches. Unlike the dual hole punch 10 however, the first and second bearing surfaces extend downwardly (rather than outwardly) from corresponding planar side walls of the lever arm 130 to engage the top end surfaces of the first and second punch. Similar to the dual hole punch 10, the lever arm is pivotally mounted via a pivot pin extending from the planar side walls of the lever arm 130, and through first and second upstanding flanges provided on the upper second portion 116 of the guide bracket 106.

A first and second spring, configured and operable as described in connection with the dual hole punch 10, are disposed around the first and second punches of the dual hole punch 100 and bias the first and second punches of the dual hole punch 100 away from the side plate 114.

The dual hole punch 100 may also include an adjustable paper guide assembly mounted to the side plate 114 and adapted to position the sheet(s) of paper into a desired alignment as described in connection with the dual hole punch 10. Unlike the dual hole punch 10 however, each of the first and second rod assemblies of the dual hole punch 100 are adapted for linear reciprocal movement within aligned apertures in opposing sides of the side plate 114 rather than base plate 102. In addition to the rod assemblies described above, it is contemplated that the paper positioning within the dual hole punch 100 may be accomplished via a lengthened engagement surface 116 having reciprocally moveable dual guide elements mounted thereon.

During operation, when in the dual hole punch 100 is not engaged, the bottom end non-circular cutting surfaces of the first and second punches are retracted into the first and second bores of the guide bracket 106. This allows the paper the be positioned, under the influence of gravitational forces, into proper alignment with the first and second punches. When in the dual hole punch 100 is engaged via downward actuation of the lever 130, the bottom end non-circular cutting surfaces of the first and second punches travel through the substantially vertically positioned sheet of paper and into the first and second dies below. When the lever 34 is released, the biasing forces of the first and second springs return the lever arm 34 to the non-engaged position. Accordingly, the paper is perforated with non-circular perforation patterns determined by the non-circular shape of the cutting surfaces of the punches.

As may be apparent from the discussion above, the hole punching devices having punch elements with non-circular cutting surfaces create non-circular perforations that are more resistant to tearing. Further, addition of the adjustable paper guide assembly to the exemplary hole punching devices described in connection with FIGS. 1-9, enables perforation alignment between separately perforated and stacked sheets of paper. Other advantages of the invention may be further apparent to those of skill in the art.

From the foregoing, it will be observed that numerous variations and modifications may be affected without departing from the scope of the novel concept of the invention. It is to be understood that no limitations with respect to the specific methods and apparatus illustrated herein is intended or should be inferred. It is, of course, intended to cover by the appended claims all such modifications as fall within the scope of the claims.

1. A dual hole punch for perforating at least one sheet of paper with dual non-circular holes, comprising:
a base plate having an engaging surface for substantially horizontal engagement of the at least one sheet of paper;
a guide bracket having a first portion and a second portion extending from the first portion of the guide bracket, the first portion of the guide bracket fixedly mounted to a first portion of the engaging surface, the second portion of the guide bracket extending adjacent to and spaced apart from a second portion of the engaging surface to define a substantially horizontal slot having a wall surface extending between the engaging surface and the second portion of the guide bracket, the second portion of the guide bracket including a first bore and a second bore extending therethrough, the first and second bores substantially perpendicular to the engaging surface;
a lever arm pivotally mounted to the guide bracket, the lever arm having a first bearing surface and a second bearing surface;
a first punch disposed in the first bore, the first punch having a top end surface and an opposing bottom end non-circular cutting surface, the top end surface of the first punch engagedly coupled to the first bearing surface of the lever arm, the first punch being operable to perforate the at least one sheet of paper in response to movement of the lever arm towards the base plate; and
a second punch disposed in the second bore, the second punch having a top end surface and an opposing bottom end non-circular cutting surface, the top end surface of the second punch engagedly coupled to the second bearing surface of the lever arm, the second punch being operable to perforate the at least one sheet of paper in response to movement of the lever arm towards the base plate.

2. The dual hole punch of claim 1, wherein each of the bottom-end non-circular cutting surfaces of the first punch and the second punch comprise a rectangular cutting surface.

3. The dual hole punch of claim 1, wherein each of the bottom-end non-circular cutting surfaces of the first punch and the second punch comprise an elongated cutting surface.

4. The dual hole punch of claim 1, wherein each of the bottom-end non-circular cutting surfaces of the first punch and the second punch comprise a D-shaped cutting surface.

5. The dual hole punch of claim 1, wherein each of the bottom-end non-circular cutting surface of the first punch and the second punch comprise a modified D-shaped cutting surface.

6. The dual hole punch of claim 1, wherein the engaging surface of the base plate includes a first die and a second die disposed therein, the first die defining a first die aperture configured to receive the bottom end non-circular cutting surface of the first punch and the second die defining a second die aperture configured to receive the bottom end non-circular cutting surface of the second punch.

7. The dual hole punch of claim 1, wherein the first bearing surface extends outwardly from a first planar side wall of the lever arm to engage the top end surface of the first punch, and wherein the second bearing surface extends outwardly from a second planar side wall of the lever arm to engage the top end surface of the second punch.

8. The dual hole punch of claim 7, wherein the guide bracket further comprises:
a first upstanding flange mounted to the top of the first portion of the guide bracket proximate to the first planar side wall of the lever arm, the first upstanding flange having an aperture therethrough; and
a second upstanding flange mounted to the top of the first portion of the guide bracket proximate to the second planar side wall of the lever arm, the second upstanding flange having an aperture therethrough, the aperture of the second upstanding flange aligned with the aperture of the first upstanding flange.

9. The dual hole punch of claim 8, further comprising a pivot pin fixedly mounted between the first planar side wall of the lever arm and the second planar side wall of the lever arm, the pivot pin extending through the aperture of the first upstanding flange and the aperture of the second upstanding flange for rotative movement of the lever arm about the pivot pin during operation of the dual hole punch.

10. The dual hole punch of claim 1, further comprising:
a first resilient member disposed around the first punch, a first end of the first resilient member coupled to a first lip radially disposed in the first bore and a second end of the first resilient member coupled to a radially extending flange disposed proximate to the top end surface of the first punch, the first resilient member biasing the first punch away from the base plate; and
a second resilient member disposed around the second punch, a first end of the second resilient member coupled to a second lip radially disposed in the second bore and a second end of the second resilient member coupled to a radially extending flange disposed proximate to the top end surface of the second punch, the second resilient member biasing the second punch away from the base plate.

11. The dual hole punch of claim 1, further comprising an adjustable paper guide assembly adapted to position the at least one sheet of paper for desired alignment with the first punch and the second punch.

12. The dual hole punch of claim 11, wherein the adjustable paper guide assembly comprises:
a first rod assembly adapted to reciprocally move within at least one aperture formed in a first side of the base plate, the first rod assembly having at least one reciprocally moveable rod and an angle bracket perpendicularly mounted to a first end of the at least one rod of the first rod assembly; and
a second rod assembly adapted to reciprocally move within at least one aperture formed in a second side of the base plate opposed to the first side of the base plate, the second rod assembly having at least one reciprocally moveable rod and an angle bracket perpendicularly mounted to a first end of the at least one rod of the second rod assembly.

13. The dual hole punch of claim 12, wherein the at least one rod of the first rod assembly is adapted to interlink with the at least one rod of the second rod assembly, and wherein linear reciprocal movement of the first rod assembly causes equal linear reciprocal movement of the second rod assembly.

14. A hole punch for perforating at least one sheet of paper with at least one non-circular hole, comprising:
a base plate having a top surface;
a guide bracket attached to the top surface of the base plate, the guide bracket having a first lower portion and at least one second portion, the second portion extending upward from the first lower portion in a substantially vertical direction, the guide bracket including a wall surface extending outward from an outer surface of the second portion of the guide bracket;
a side plate having an engagement surface extending in a substantially vertical direction, the side plate having a lower portion disposed adjacent to and spaced from the second portion of the guide bracket,
the wall surface of the guide bracket, the second portion of the guide bracket and the lower portion of the side plate forming a slot adapted to support the at least one piece of paper in a substantially vertical direction; and
a punch assembly mounted in the guide bracket, the punch assembly including at least one reciprocally and selectively driven punch, the at least one punch having a top end surface and an opposing bottom end non-circular cutting surface,
the side plate including at least one die, the at least one die adapted to receive the bottom end non-circular cutting surface of the at least one punch when the at least one punch is driven towards the side plate by the punch assembly.

15. A dual hole punch for perforating at least one sheet of paper with dual non-circular holes, comprising:
a base plate having a top surface;
a guide bracket attached to the top surface of the base plate, the guide bracket having a first lower portion and at least one second portion, the second portion extending upward from the first lower portion in a substantially vertical direction, the guide bracket including a wall surface extending outward from an outer surface of the second portion of the guide bracket;
a side plate having an engagement surface extending in a substantially vertical direction, the side plate having a lower portion disposed adjacent to and spaced from the second portion of the guide bracket,
the wall surface of the guide bracket, the second portion of the guide bracket and the lower portion of the side plate forming a slot adapted to support the at least one piece of paper in a substantially vertical direction; and
a punch assembly mounted in the guide bracket, the punch assembly including a first punch and a second punch, the first punch having a top end surface and an opposing bottom end non-circular cutting surface, and the second punch having a top end surface and an opposing bottom end non-circular cutting surface,
the side plate including a first die and a second die, the first die adapted to receive the bottom end non-circular cutting surface of the first punch and the second die adapted to receive the bottom end non-circular cutting surface of the second punch when the first punch and the second punch are driven towards the side plate by the punch assembly.

16. The dual hole punch of claim 15, wherein each of the bottom end non-circular cutting surfaces of the first punch and the second punch comprise a rectangular cutting surface.

17. The dual hole punch of claim 15, wherein each of the bottom end non-circular cutting surfaces of the first punch and the second punch comprise an elongated cutting surface.

18. The dual hole punch of claim 15, wherein each of the bottom end non-circular cutting surfaces of the first punch and the second punch comprise a D-shaped cutting surface.

19. The dual hole punch of claim 15, wherein each of the bottom end non-circular cutting surfaces of the first punch and the second punch comprise a modified D-shaped cutting surface.

20. The dual hole punch of claim 15, wherein the punch assembly comprises:
a first bore extending through the second portion of the guide bracket and substantially perpendicular to the engagement surface, the first bore sized to receive the first punch;
a second bore extending through the second portion of the guide bracket apart from the first bore and substantially perpendicular to the engagement surface, the second bore sized to receive the second punch;
a lever arm pivotally mounted to the second portion of the guide bracket, the lever arm having a first bearing surface to engage the first punch and having a second bearing surface to engage the second punch;
a first resilient member disposed around the first punch, a first end of the first resilient member coupled to a first lip radially disposed in the first bore and a second end of the first resilient member coupled to a radially extending flange disposed proximate to the top end surface of the first punch, the first resilient member biasing the first punch away from the side plate; and
a second resilient member disposed around the second punch, a first end of the second resilient member coupled to a second lip radially disposed in the second bore and a second end of the second resilient member coupled to a radially extending flange disposed proximate to the top end surface of the second punch, the second resilient member biasing the second punch away from the side plate.

21. The dual hole punch of claim 20, wherein the first bearing surface extends downwardly from a first planar side wall of the lever arm to engage the top end surface of the first punch, and wherein the second bearing surface extends downwardly from a second planar side wall of the lever arm to engage the top end surface of the second punch.

22. The dual hole punch of claim 21, wherein the guide bracket further comprises:
a first upstanding flange mounted to the second portion of the guide bracket proximate to the first planar side wall of the lever arm, the first upstanding flange having an aperture therethrough; and
a second upstanding flange mounted to the second portion of the guide bracket proximate to the second planar side wall of the lever arm, the second upstanding flange having an aperture therethrough, the aperture of the second upstanding flange aligned with the aperture of the first upstanding flange.

23. The dual hole punch of claim 22, further comprising a pivot pin fixedly mounted between the first planar side wall of the lever arm and the second planar side wall of the lever arm, the pivot pin extending through the aperture of the first upstanding flange and the aperture of the second upstanding flange for rotative movement of the lever arm about the pivot pin during operation of the dual hole punch.

24. The dual hole punch of claim 15, further comprising an adjustable paper guide assembly adapted to position the at least one sheet of paper for desired alignment with the first punch and the second punch.

25. The dual hole punch of claim 24, wherein the adjustable paper guide assembly comprises:
a first rod assembly adapted to reciprocally move within at least one aperture formed in a first side of the side plate, the first rod assembly having at least one reciprocally moveable rod and an angle bracket perpendicularly mounted to a first end of the at least one rod of the first rod assembly; and
a second rod assembly adapted to reciprocally move within at least one aperture formed in a second side of the side plate, the second rod assembly having at least one reciprocally moveable rod and an angle bracket perpendicularly mounted to a first end of the at least one rod of the second rod assembly, the second side of the side plate opposed to the first side of the side plate.

26. The dual hole punch of claim 25, wherein the at least one rod of the first rod assembly is adapted to interlink with the at least one rod of the second rod assembly, and wherein movement of the first rod assembly causes equal movement in the second rod assembly.
